(19) United States
(12) Patent Application Publication
(10) Pub. No.: US 2019/0311335 A1
(43) Pub. Date: Oct. 10, 2019

(54) SYSTEMS AND METHODS FOR IN-APPLICATION CONTENT MANAGEMENT

(71) Applicant: Microsoft Technology Licensing, LLC, Redmond, WA (US)

(72) Inventors: Jared GREINER, Seattle, WA (US); John THORNTON, Kirkland, WA (US); Aaron BUCKLEY, Mercer Island, WA (US)

(73) Assignee: Microsoft Technology Licensing, LLC, Redmond, WA (US)

(21) Appl. No.: 15/975,123

(22) Filed: May 9, 2018

Related U.S. Application Data
(60) Provisional application No. 62/655,127, filed on Apr. 9, 2018.

(51) Int. Cl. G06Q 20/06; G06F 21/62; G06F 21/12

(52) U.S. Cl. CPC G06Q 20/065; G06F 21/121; G06F 21/629

(57) ABSTRACT

The disclosed implementations provide a process to streamline in-application purchasing of unlockable content. The disclosed implementations can determine an amount of resources with a virtual currency package on an application store, present a selectable option to purchase the package in real currency, and provide access to the unlockable content stored on a server associated with the developer of the application in response to selecting the package and payment of the real currency amount.

### CROSS-REFERENCE TO RELATED APPLICATIONS

This application claims priority to U.S. Provisional Patent Application No. 62/655,127 filed on Apr. 9, 2018, the entire contents of which is hereby incorporated by reference.

### FIELD OF THE DISCLOSURE

The present disclosure relates generally towards application store resource management.

### BACKGROUND

There are a variety of application platforms for video game consoles, mobile devices, and computing devices. These platforms can communicate with an application store (e.g., iOS App Store, Google Play Store, Microsoft Store, etc.) to install and/or update an application, as well as provide functionality for in-game purchases. Users can browse through different application categories on the application store and view information about each application such as a rating, an installation size, developer, reviews, etc. The application store may be curated.

Developers may upload content to the application store. Some applications have unlockable content that can be unlocked from within an application operating on a device (e.g., a smartphone). Content may be considered “locked” if it is not capable of being used by an application. Generally, content may become “unlocked” if purchased, or upon completion of one or more tasks. The unlocked content may then be used by the application. For example, a skin pack may be locked and require a purchase of $3.99 to be unlocked. If a user purchases the skin pack, then the user may apply the skin pack to the characters of the corresponding game. Other applications may utilize a similar mechanism for creating locked content. For example, cut scenes of a movie, additional functionality for an application, or extra features of an application, may be locked.

For each unlockable item in an application store, a developer or content provider may create a content package. Because there are multiple different application platforms, each with a unique application store, the content provider must create such a content package for each application store. Furthermore, each application store may have an associated price or other conditions for unlocking the content. In the event that a particular application has content that can be unlocked, for example by making a purchase, then each content package may be separately managed in each application store. For example, if a game has one hundred pieces of unlockable content via an in-application purchase (e.g., purchased from the within the application operating on the device), then there may be three hundred pieces of content to manage in the different application stores. That is, the developer may be required to manage individually such content for each instance in each application store. This can create enormous burdens upon a developer or content creator to maintain such a large collection of packages. In some instances, a virtual currency may be utilized for unlockable content. However, this may can complicate user experiences for in-application purchases because the consumer may first purchase in real currency the required amount of virtual currency, and then purchase the unlockable content.

Thus, a mechanism that allows in-application purchases to be made without having to make the extra steps of purchasing virtual currency may address the deficiencies identified above.

### SUMMARY

According to an implementation, a system is provided that may include a non-transitory memory and one or more hardware processors that are coupled thereto. The one or more processors may be configured to execute the instructions to cause the system to perform the following operations. In an implementation, a finite number of virtual currency packages may be provided to an application store. Each virtual currency package may be purchasable via an application store for an amount of real currency. One or more unlockable content packages for an application may be maintained on a server that is not associated with the application store. Each unlockable content package may have an associated virtual currency amount that is required to access the unlockable content for the application. A request to access one unlockable content packages may be received from an application operating on the computing device. One of the virtual currency packages may be determined to be presented based upon the available virtual currency packages in the application store. The virtual currency package may be presented as a selectable option in the application operating on a computing device. The selected virtual currency package may provide at least a minimum amount of virtual currency to access the desired unlockable content package. In some configurations, the system may determine the amount of virtual currency already associated with the application on the computing device such as by using a user account as described earlier. A selection of virtual currency package that is displayed as a selectable option in the application on the computing device may be received by the server (e.g., the developer of the application). The server may automatically purchase the selected virtual currency package and exchanging the virtual currency for access to the desired unlockable content package stored on the server. Access to the desired unlockable content package may include sending the computing device the desired unlockable content package for execution on the computing device as explained above.

In some configurations, the indication of the virtual currency may be sent to the computing device for presentation as a selectable option.

In some configurations, the receipt of a selection of the virtual currency packages may also include authorization to transact an exchange of real currency for the selected virtual currency package on the application store by the server of the developer of the application.

In an implementation, a computer-implemented method is provided. A finite number of virtual currency packages may be provided to an application store. Each virtual currency package may be purchasable via an application store for an amount of real currency. One or more unlockable content packages for an application may be maintained on a server that is not associated with the application store. Each unlockable content package may have an associated virtual currency amount that is required to access the unlockable content for the application. A request to access one unlockable content packages may be received from an application operating on the computing device. One of the virtual currency packages may be determined to be presented based upon the available virtual currency packages in the application store. The virtual currency package may be presented as a selectable option in the application operating on a computing device. The selected virtual currency package may provide at least a minimum amount of virtual currency to access the desired unlockable content package. In some configurations, the system may determine the amount of virtual currency already associated with the application on the computing device such as by using a user account as described earlier. A selection of virtual currency package that is displayed as a selectable option in the application on the computing device may be received by the server (e.g., the developer of the application). The server may automatically purchase the selected virtual currency package and exchanging the virtual currency for access to the desired unlockable content package stored on the server. Access to the desired unlockable content package may include sending the computing device the desired unlockable content package for execution on the computing device as explained above.

In an implementation, a non-transitory computer readable medium is provided. The medium may store machine-readable instructions that, when executed by one or more processors, cause the one or more processors to perform the following operations. A finite number of virtual currency packages may be provided to an application store. Each virtual currency package may be purchasable via an application store for an amount of real currency. One or more unlockable content packages for an application may be maintained on a server that is not associated with the application store. Each unlockable content package may have an associated virtual currency amount that is required to access the unlockable content for the application. A request to access one unlockable content packages may be received from an application operating on the computing device. One of the virtual currency packages may be determined to be presented based upon the available virtual currency packages in the application store. The virtual currency package may be presented as a selectable option in the application operating on a computing device. The selected virtual currency package may provide at least a minimum amount of virtual currency to access the desired unlockable content package. In some configurations, the system may determine the amount of virtual currency already associated with the application on the computing device such as by using a user account as described earlier. A selection of virtual currency package that is displayed as a selectable option in the application on the computing device may be received by the server (e.g., the developer of the application). The server may automatically purchase the selected virtual currency package and exchanging the virtual currency for access to the desired unlockable content package stored on the server. Access to the desired unlockable content package may include sending the computing device the desired unlockable content package for execution on the computing device as explained above.

According to an implementation, a system is provided that includes a non-transitory memory for storing instructions and one or more hardware processors that are coupled thereto. The one or more processors may be configured to execute the instructions to cause the system to perform the following operations. In an implementation, an amount of a virtual currency that may be required to access the unlockable content for the application may be determined. The amount of virtual currency required to access the unlockable content may be compared to one or more virtual currency packages available on an application store. The application store may be communicatively coupled to the computing device on which the application is operating. The virtual currency packages may be available for purchase with real currency. One of the virtual currency packages may be selected to present as a selectable option. The selected virtual currency package may provide at least the amount of virtual currency required to access the unlockable content. The selectable option to access the unlockable content may be presented. The selectable option may include the previously selected virtual currency package with a cost of the selected virtual currency package displayed in real currency. The selectable option may also include a simultaneous display of the amount of virtual currency required to access the unlockable content. A selection of the virtual currency package may be received. The unlockable content for the application may be automatically purchased, thereby making the unlockable content accessible to the application. In some configurations, a package may be received from a server of a developer of the application, and the package may include the unlockable content. The package may be executed on the computing device to install the unlockable content.

In some configurations, the operations may further include receiving a request to provide access to unlockable content for the application.

In some configurations, an amount of currency provided by the selected virtual currency package exceeds the amount of virtual currency required to access the unlockable content for the application. A difference between the amount of virtual currency that may be required to access the unlockable content and the amount of virtual currency provided by the selected virtual currency package may be determined. A message may be generated that includes an indication of the difference. The message may be displayed in the application on the computing device.

In some configurations, an amount of virtual currency associated with a user (e.g., a user account and/or associated with the application) of the application on the computing device may be determined. The determination of the virtual currency packages to present with the selectable option may be based upon the amount of virtual currency associated with the user (e.g., user account and/or associated with the application) of the application on the computing device.

In an implementation, a computer-implemented process is provided. An amount of a virtual currency that may be required to access the unlockable content for the application may be determined. The amount of virtual currency required to access the unlockable content may be compared to one or more virtual currency packages available on an application store. The application store may be communicatively coupled to the computing device on which the application is operating. The virtual currency packages may be available for purchase with real currency. One of the virtual currency packages may be selected to present as a selectable option. The selected virtual currency package may provide at least the amount of virtual currency required to access the unlockable content. The selectable option to access the unlockable content may be presented. The selectable option may include the previously selected virtual currency package with a cost of the selected virtual currency package displayed in real currency. The selectable option may also include a simultaneous display of the amount of virtual currency required to access the unlockable content. A selection of the virtual currency package may be received. The unlockable content for the application may be automatically purchased, thereby making the unlockable content accessible to the application. In some configurations, a package may be received from a server of a developer of the application, and the package may include the unlockable content. The package may be executed on the computing device to install the unlockable content.

In an implementation, a non-transitory computer readable medium is provided. The medium may store machine-readable instructions that, when executed by one or more processors, cause the one or more processors to perform the following operations. The amount of virtual currency required to access the unlockable content may be compared to one or more virtual currency packages available on an application store. The application store may be communicatively coupled to the computing device on which the application is operating. The virtual currency packages may be available for purchase with real currency. One of the virtual currency packages may be selected to present as a selectable option. The selected virtual currency package may provide at least the amount of virtual currency required to access the unlockable content. The selectable option for access to the unlockable content may be presented. The selectable option may include the previously selected virtual currency package with a cost of the selected virtual currency package displayed in real currency. The selectable option may also include a simultaneous display of the amount of virtual currency required to access the unlockable content. A selection of the virtual currency package may be received. The unlockable content for the application may be automatically purchased, thereby making the unlockable content accessible to the application. In some configurations, a package may be received from a server of a developer of the application, and the package may include the unlockable content. The package may be executed on the computing device to install the unlockable content.

Additional features, advantages, and embodiments of the disclosed subject matter may be set forth or apparent from consideration of the following detailed description, drawings, and claims. Moreover, it is to be understood that both the foregoing summary and the following detailed description are exemplary and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 is an example configuration of a system according to an implementation disclosed herein.

FIG. 2 is an example of a selectable option according to an implementation disclosed herein.

FIG. 3 is an example of a computer-implemented process according an implementation disclosed herein.

FIG. 4 is an example computing device suitable for implementing embodiments of the presently disclosed subject matter.

FIG. 5 shows an example network arrangement according to an embodiment of the disclosed subject matter.

### DETAILED DESCRIPTION

The following discussion is directed to various exemplary implementations. However, one possessing ordinary skill in the art will understand that the implementations disclosed herein have broad application, and that the discussion of any implementation is meant only to be an example of that implementation, and not intended to suggest that the scope of the disclosure, including claims is limited to that implementation.

As disclosed herein, when a user attempts to activate unlockable content of an application, the resources (e.g., virtual currency) required to unlock the content can be determined, the resources can be correlated with a virtual currency package available in an application store, and based upon unlocking or purchasing the virtual currency package, provide access to the unlockable content. In some configurations, the virtual currency package can fall into a finite number of categories. The finite categories may not perfectly correspond to the unlockable content. The cost of the unlockable content can be presented in a local currency (e.g., a real currency such as U.S. dollars, Euros, Yen, etc.). The cost of the unlockable content, therefore, can be directly compared to the local currency, which can be easy for a user to comprehend. Furthermore, the developer of the application does not have to maintain content packages (that may be provided as selectable options) in various application stores for various platforms to transact the local currency to the virtual currency.

Previously existing processes for unlocking content may involve several steps that may unnecessarily complicate a transaction, and require multiple packages be maintained on an application store across several different platforms. An application operating on a computing device (e.g., a smartphone, a smartwatch, a computer, a game console, etc.) may receive a request to obtain unlockable content. Unlockable content may refer to an item presented for sale in the application such as a skin pack, a power-up, a new/improved ability, and/or a new/improved functionality (e.g., the ability to view a certain file type or document, modify a photo in a particular manner, etc.). A user may browse and/or select unlockable content from within the application. The unlockable content may be displayed with an offer to access the unlockable content by paying an amount in the virtual currency. In the event the user does not possess a sufficient amount of the virtual currency, the user may be prompted to purchase more of the virtual currency first, before purchasing the unlockable item (with the virtual currency). The virtual currency may be purchased by a separate transaction. Once the user has sufficient virtual currency to access the unlockable content, the user may return to the original offer to access the unlockable content, and make the purchase using the newly acquired virtual currency.

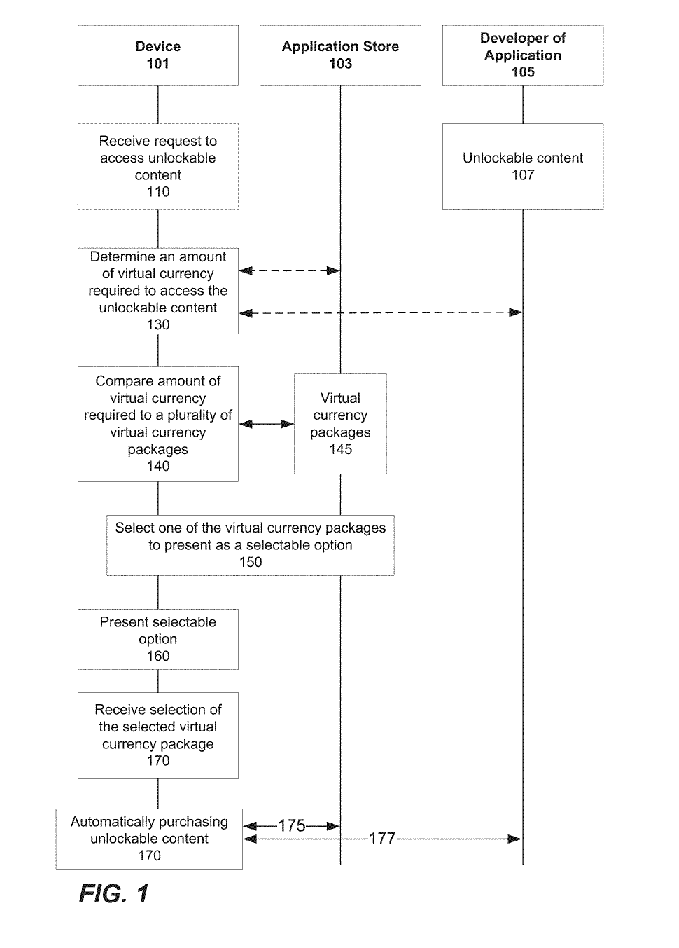

FIG. 1 is an example configuration of a system according to an implementation disclosed herein. The system may include a computing device 101 that can refer to a computer, a smartphone, a smartwatch, a game console, a media streaming device, etc. The system may include an application store 103 as described earlier to which the computing device 101 can be communicatively coupled, and a server of a developer or maintainer 105 of an application. The developer of an application may refer to an individual developer, a software development company, and/or an entity that maintains an application by presenting content, updates to the application, and/or a new version of an application. The developer of the application 105 may have a server that can be communicatively coupled to the computing device 101 on which the application is executed and/or operated. Unlockable content 107 may be stored to a database or the like of the developer of the application 105 and presented and/or provided to the computing device 101 when access to the content 107 is requested and/or obtained.

An application may refer to a computer program that performs various functions, tasks, and/or activities. An application may be installed on the computing device 101 via the application store 103. Subsequent to initial installation, the application may be updated to fix programming bugs and/or to add/improve functionality (including adding or allowing access to unlockable content). Installation of the application and/or updating an application may refer to making the application ready for execution according to the requirements of the application, the computing device, and the operating system of the computing device. There many different types of applications (e.g., word processing, photo editing, video game, document management, etc.), and the disclosed implementations herein are not limited to any particular type of application.

In an implementation, the system may include a non-transitory memory for storing instructions and one or more hardware processors that are coupled thereto. A processor may be configured to execute the instructions stored in the memory to cause the system to perform one or more operations. The operations of the system disclosed herein may be implemented on a single device, or on multiple devices. As disclosed herein, a request to provide access to unlockable content 107 for the application may be received at 110. The request may be received via the application operating on the computing device 101. Unlockable content, as explained above, may refer to content to which the application does not have access. The unlockable content 107, for example, may refer to a skin pack for a character in a video game, deleted scenes of a movie, functionality of performing optical character recognition for a word processing program, etc. The unlockable content 107 may be provided in exchange for a virtual currency. A virtual currency may refer to a currency unique to the application or a fictional currency that may not have redeemable value to a real currency. An example of a virtual currency is Minecraft coins, which may allow a user to purchase content from an application store 103 and/or the developer of the application 105. In some configurations, the process at 110 is optional as indicated in dashed lines. That is, for any unlockable content 107, the system may determine an amount of virtual currency required to access the unlockable content at 130, perform the comparison and selection at 140 and 150, respectively, and present the selectable option at 160. In such configurations, therefore, the system does not require a prompt from the computing device, but instead performs the operations as described below (i.e., skips the operation at 110).

An amount of a virtual currency that may be required to access the unlockable content for the application may be determined at 130. For example, the system may determine that the unlockable content 107 the application is attempting to access has a cost of 500 units of the virtual currency. The amount required to access the unlockable content 107 may be provided by the application. The amount required to access the unlockable content may be updated periodically by the developer of the application and/or the application store as new and/or updated versions of the application are provided or as a discount feature. For example, around a holiday, the unlockable content 107 may be provided at a 10% discount. Thus, the amount that may be required to access the unlockable content 107 may be determined from the application itself. In some configurations, the amount required to access the unlockable content may be determined by requesting the amount from one of the application store 103 or the developer of the application 105. In such configurations, the application store or developer of the application may respond to the query from the application on the computing device 101 with the amount. These possible configurations are indicated with dashed lines in FIG. 1 for each of the application store 103 and the developer of the application 105.

The amount of virtual currency required to access the unlockable content 107 may be compared to one or more virtual currency packages 145 available on an application store at 140. The virtual currency packages on the application store may be purchased with real currency. The real currency may refer to the local currency of the computing device 101. In the application store 103 there may be one or more options to purchase a package. The packages may have distinct price points such as $1.99, $2.99, $3.99, etc. Increments in the price point for each package may correspond to rules of the application store 103. For example, an application store may require that a package can have any value beginning at $0.99 and incremented at one dollar intervals. The virtual currency package 145 provided by the application store 103 may provide a given amount of the virtual currency in exchange for a real currency amount. The amount of virtual currency 145 required to access the unlockable content 107 may be compared to each virtual currency package 145 provided on the application store 103. The comparison at 140 may be performed by querying the amount of virtual currency provided by each package 145. For example, the application store 103 may receive the amount of currency required to access the unlockable content 107 from the computing device 101, and compare this amount to the amount of virtual currency provided by each package. In some configurations, the comparison may be performed by receiving the amount of virtual currency required to access the unlockable content 107 from the computing device 101 and the virtual currency package 145 that provides an amount of virtual currency that is greater than or equal to the amount required to unlock the content may be selected.

The virtual currency package 145 that provides a sufficient number of virtual currency to access the unlockable content 107 may be selected at 150. A sufficient amount of virtual currency may refer to the greater than or equal to the amount of virtual currency required to access the unlockable content 107. In some configurations, the operation at 150 can be performed by the application store 103, while in other configurations it can be performed at the computing device 101. After the comparison of the required amount of virtual currency to one or more packages available on the application store 103 at 140, the package that is determined to provide greater than or equal to the amount virtual currency required to access the unlockable content 107 may be selected at 150 for presentation in as a selectable option.

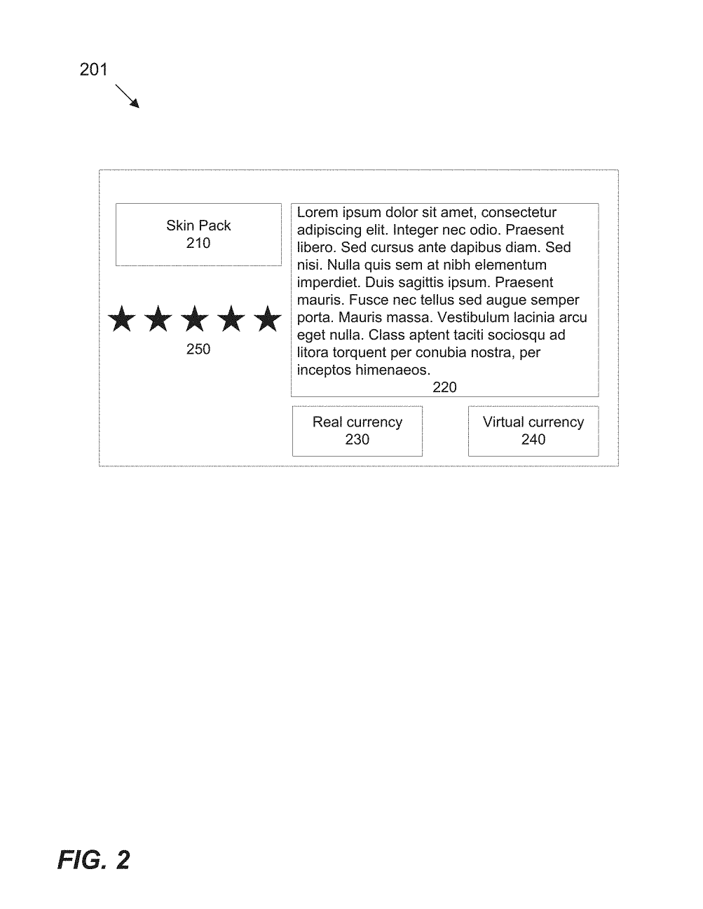

At 160, the selectable option may be presented on the computing device 101. The selectable option may include an indication of the selected virtual currency package that includes a cost of the of the selected package displayed in real currency as well as the amount of the virtual currency required to access the unlockable content 107 displayed in virtual currency. A selectable option may refer to any feature of an application that is presented on a display of the computing device and selectable by a user. FIG. 2 is an example of a selectable option according to an implementation disclosed herein. In FIG. 2, the selectable option 201 is for a video game skin package 210. The selectable option 201 may be displayed on the computing device 101 via the display associated with the computing device 101. The selectable option 201 may be displayed as a sub-container of the application operating on the computing device 101 or as a self-contained window on the computing device 101. The selectable option 201 may include a description of the content 220, which in this example may include a description of the skin pack 210, as well as a rating 250 or other such content. In addition, the selectable option 201 may display a button or other similar visual indication of the cost of the selectable option 201 for the skin pack 210 in both real currency 230 (e.g., the local currency of the computing device 101) and the virtual currency 240. The present disclosure is not limited to the example representation of the selectable option 201 provided in FIG. 2. For example, in some configurations, the virtual currency and the real currency may be displayed as single contained selectable visual indication. In some configurations, there may be a single selectable indication for “purchase” or the like, which, upon selection by a user, generates a message displayed on the computing device that indicates that the user may pay for the package using either virtual currency or real currency. Thus, the selectable option 201 may be presented in a variety of different ways.

Returning to FIG. 1, the computing device 101 may receive a selection of the selected virtual currency package that is displayed in real currency at 170. For example, a user may click or tap a selectable icon or other visual representation of the real currency. At 180, the unlockable content is automatically purchased, thereby making the content accessible to the application on the computing device 101. The unlockable content 107 may be obtained from the developer of the application 105. Once the unlockable content is purchased, access to the unlockable content 107 may be provided on the application. For example, the unlockable content may enable additional functionality of the application and/or add features to the application, or otherwise enhance the user experience of the application according to the description of the unlockable content 107. The unlockable content may be provided as a package that is received from the server of the developer of the application 105, which may then be executed on the computing device 101 to, for example, install and/or update the application and/or to allow access to the unlockable content. In some configurations, the unlockable content may already be installed with the application or it may be feature that the user does not have access to, and access to the unlockable content may include removing a block to the unlockable content. For example, a user account associated with the application may have a flag to indicate whether the user account should have access to the unlockable content. In the event the user purchases the unlockable content, the flag may be set to establish that the user has access to the unlockable content.

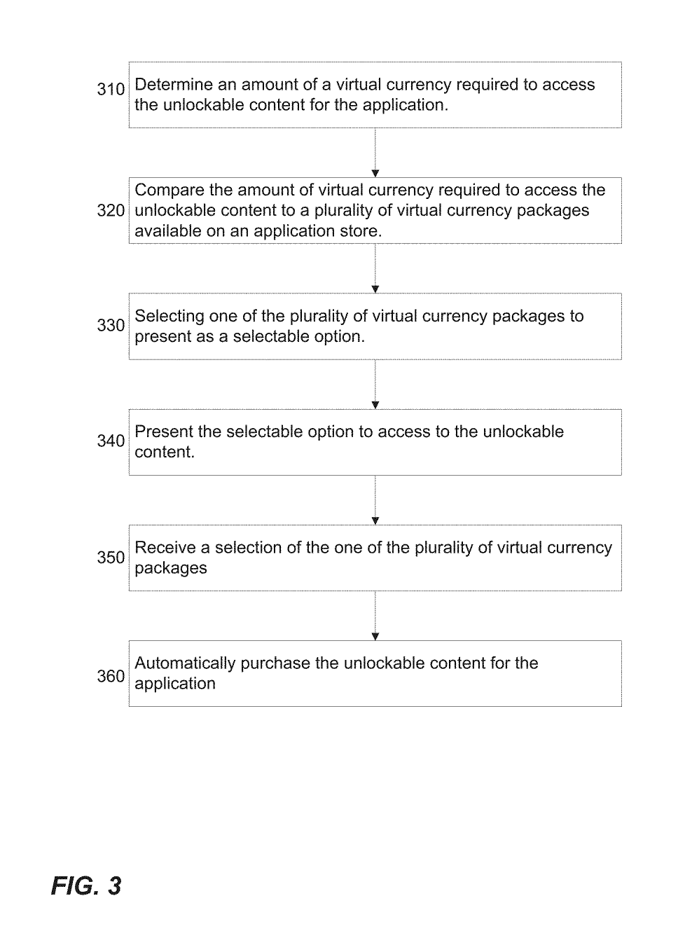

By providing access to the unlockable content as disclosed in FIG. 1 and FIG. 3, the application developer may not have to maintain a large amount of packages on the application store of each platform. Instead, packages corresponding to the unlockable content can be maintained on a server of the developer of the application. Furthermore, the user does not need to perform extra steps of, for example, separately purchasing the required amount of virtual currency to unlock the content. The disclosed implementations can automatically purchase the required amount of virtual currency, and obtain the unlockable content from the developer of the application in a seamless process to the user.

In some configurations, the selection of the real currency selectable option at 170 may cause the system to purchase the virtual currency package from the application store at 175, and request the unlockable content 107 from the developer of the application 105 at 177. The request may include deducting the amount of virtual currency from an account of a user that is associated with the application and/or the application store 103. The account for the application may be stored with the developer of the application 105 so that access to unlockable content 107 can be provided across multiple devices. As an example, a video game may be provided on a computer and a smartphone. The user may desire to play the game on both devices. Thus, the use of a user account stored with the developer of the application 105 may allow the user to have access across multiple platforms and/or devices. The user account may include information about the user such as a user identification, user credentials (e.g., user name and password), payment information (e.g., a credit card or other such account), an indication of what content a user has access too, an indication of a user's progress, and other such information that may be pertinent to the application (e.g., a user's rating of the application, a user's ranking, a user achievement, etc.).

In some configurations, when the request is received at 170, the system may generate a message to the user requesting the user to confirm the purchase. For example, the message may be displayed on the device 101 and request the user to confirm the purchase by selecting a “yes” or discontinuing the purchase by selecting “no.” Other such confirmation screens and/or messages may be generated and provided without limitation. Once a confirmation is obtained, the system may proceed to the operation at 180.

In some configurations, the virtual currency package 145 may provide more virtual currency than is required to access the unlockable content 107. For example, a $1.75 (real currency) amount of virtual currency may provide a sufficient amount to access the unlockable content (e.g., based upon the exchange rate of the real currency for the virtual currency). However, the application store 103 may only provide virtual currency packages in certain amounts. In the event that the amount of virtual currency provided by the virtual currency package exceeds the amount of virtual currency required to access the unlockable content 107, the difference between the amount of virtual currency required to access the unlockable content 107 and the amount of virtual currency provided by the virtual currency package 145 may be determined. Once the process at 170 has been completed, the system may generate a message that indicates the difference, and display this message in the application on the computing device 101. For example, the message might indicate, “congratulations, you have 50 extra units of virtual currency” where the 50 units of the virtual currency may be the determined difference. The above message is merely provided as an example and the disclosed implementations herein are not limited to this message.

According to an implementation, at 140, the comparison process may include determining an amount of virtual currency associated with a user of the application on the computing device. As explained above, the user may maintain an account that has an existing amount of virtual currency. Thus, in comparing the virtual currency package to select to include with the selectable option, the system may determine the difference between the existing amount of virtual currency and the amount of virtual currency required to access the unlockable content 107. The package 145 that is selected may be based upon this difference. For example, if a user account has 200 units of virtual currency, and the unlockable content requires 500 units of virtual currency to purchase, then the user has a 300 unit deficiency. The system may search for a virtual currency package 145 that provides at least 300 units of virtual currency. In some configurations, the determination of the user's existing virtual currency may be communicated to the computing device 101 and/or application store 103 by querying and receiving such information from a server of the developer of the application 105. In some configurations, the application store 103 may perform the comparison at 140 and it may query the computing device 101 and/or the server of the developer of the application 105 to obtain the existing amount of virtual currency associated with the user.

FIG. 3 is an example of a computer-implemented process according an implementation disclosed herein. At 310, an amount of a virtual currency that may be required to access the unlockable content for the application may be determined. As explained earlier, the virtual currency may be a fictional currency or an in-application currency, which may be distinguished from a real or local currency. The amount of the virtual currency that may be required to access the unlockable content may be associated with the unlockable content. For example, during installation or update of the application, it may include selectable options for one or more content items. In some configurations, the selectable options for one or more content offerings may be obtained from the application store and/or developer of an application, as described above, and displayed on a computing device that is operating the application. For example, a skin pack may be associated with a purchase price of 500 units of virtual currency. In some configurations, a request to provide access to the unlockable content may precede the process at 310. The request may prompt the application to query at least one of the application store and/or a server of the developer of the application to determine the amount required to purchase the unlockable content, as well as determine a real currency value to purchase at least as much virtual currency as required to access the unlockable content.

In some configurations, it may be determined whether the user has sufficient virtual currency to access the unlockable content before proceeding at 310 by comparing the amount of virtual currency currently available to the user account associated with the application to the amount of virtual currency required to access the unlockable content. In the event that the amount of available virtual currency is lower than the amount required to access the unlockable content, then the process may proceed beginning at 310.

At 320, the amount of virtual currency required to access the unlockable content may be compared to one or more virtual currency packages available on an application store. The computing device that operates the application may be communicatively coupled to the application store. For example, the application may communicate over the Internet with the application store. The one or more virtual currency packages may be available for purchase with real currency as explained above.

At 330, one of the virtual currency packages may be selected to present with a selectable option. As explained earlier, the selected package may be based upon a comparison of the amount of virtual currency required to purchase the unlockable content, and/or take into account the amount of virtual currency currently available to the user account of the application. The selected virtual currency package may provide at least the amount of virtual currency required to access the unlockable content. In some configurations, the selected package may include more than the amount of virtual currency required to access the application.

At 340, the selectable option to access to the unlockable content may be presented. The selectable option may be presented on the computing device on which the application is operating. The selectable option may include the selected virtual package and represent the selected virtual package by displaying a real currency amount associated with the purchase of the virtual package. The selectable option may also include a display of the amount of virtual currency required to access the unlockable content. In some configurations, the selectable option may display an indication to purchase the unlockable content. In the event that the purchase button is selected, a message may be generated and displayed on the computing device offering the user to purchase the package using virtual currency, or to spend a real currency amount to acquire the required virtual currency to purchase the package. Thus, a selectable option is not necessarily limited to a single message, and may refer to a sequence of messages that involve presenting the option to purchase access to the unlockable content using real currency or virtual currency.

At 350, a selection of the virtual currency package selected at 330 may be received. For example, a user may select a visual indication (e.g., a button or tab) that shows the real currency value of the virtual currency package. The selectable option may indicate that spending the real currency amount will purchase a sufficient amount of virtual currency to access the unlockable content.

At 360, the unlockable content for the application may be automatically purchased, thereby making the unlockable content accessible to the application. For example, in response to the user confirming spending the real currency amount by selecting the visual indication of the selected virtual currency package at 350, access to the unlockable content may be provided by the application exchanging the real currency amount associated with the virtual currency package for the virtual currency amount provided by the virtual currency package. The exchange may be transacted via an application store. The application may also communicate with a server of the developer of the application to exchange the amount of virtual currency required to access the unlockable content for access to the unlockable content. In the event that access to the unlockable content requires an update to the application or installation of a package to add the content, a package may be sent from the sever of the developer of the application to the computing device on which the application is operating. The package may be executed to install and/or update the application. As explained earlier, in some configurations, access to the unlockable content may not require modification of the application and/or installation of an additional package. Rather, an account of the user associated with the application, or the application itself may receive an indication that the user now has access to the unlockable content.

According to an implementation, a system is provided that may include a non-transitory memory and one or more hardware processors that are coupled thereto, as described earlier. The system may provide a finite number of virtual currency packages to an application store. As explained above, virtual currency package may be purchasable via an application store for an amount of real currency. One or more unlockable content packages for an application may be maintained on a server that is not associated with the application store. Not being associated with the application store may indicate that the server is not under control of the entity maintaining/managing/operating the application store server. The server with the unlockable content packages may be associated with a developer of an application. The application may be findable and installable via the application store on a computing device of a user. Each unlockable content package may have an associated virtual currency amount that is required to access the unlockable content for the application. A request to access one unlockable content packages may be received from an application operating on the computing device. One of the virtual currency packages may be determined to be presented based upon the available virtual currency packages in the application store. The virtual currency package may be presented as a selectable option in the application operating on a computing device. The selected virtual currency package may provide at least a minimum amount of virtual currency to access the desired unlockable content package. For example, if 500 units of virtual currency are required to access the unlockable content package, then the minimum amount of virtual currency may be 500 units. In some configurations, the system may determine the amount of virtual currency already associated with the application on the computing device such as by using a user account as described earlier. A selection of virtual currency package that is displayed as a selectable option in the application on the computing device may be received by the server (e.g., the developer of the application). The server may automatically purchase the selected virtual currency package and exchanging the virtual currency for access to the desired unlockable content package stored on the server. Access to the desired unlockable content package may include sending the computing device the desired unlockable content package for execution on the computing device as explained above.

In some configurations, the indication of the virtual currency may be sent to the computing device for presentation as a selectable option. For example, the server of the developer of the application may determine that virtual currency package Y should be presented, which may be communicated to the computing device over the Internet. The computing device may query the application store for information about virtual currency package Y to determine how to present Y as a selectable option.

In some configurations, the receipt of a selection of the virtual currency packages may also include authorization to transact an exchange of real currency for the selected virtual currency package on the application store by the server of the developer of the application.

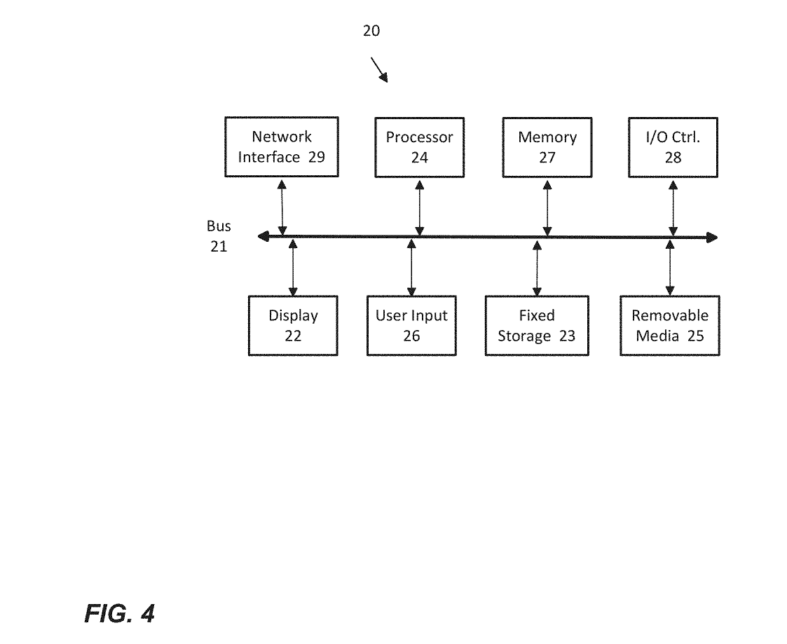

Embodiments of the presently disclosed subject matter may be implemented in and used with a variety of component and network architectures. FIG. 4 is an example computer or computing device 20 (e.g., electronic device such as a smartphone, smartwatch, tablet, laptop, personal computer, etc.) suitable for implementing embodiments of the presently disclosed subject matter. The computer 20 includes a bus 21 which interconnects major components of the computer 20, such as a central processor 24, a memory 27 (typically RAM, but which may also include read-only memory (“ROM”), flash RAM, or the like), an input/output controller 28, a user display 22, such as a display screen via a display adapter, a user input interface 26, which may include one or more controllers and associated user input devices such as a keyboard, mouse, camera, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include ROM or flash memory (neither shown), and RAM (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks. Many other devices or components (not shown) may be connected in a similar manner (e.g., digital cameras or speakers). Conversely, not all of the components shown in FIG. 4 need to be present to practice the present disclosure. The components can be interconnected in different ways from that shown. The operation of a computer such as that shown in FIG. 4 is readily known in the art and is not discussed in detail in this application. Code to implement the present disclosure can be stored in computer-readable storage media such as one or more of the memory 27, fixed storage 23, removable media 25, or on a remote storage location.

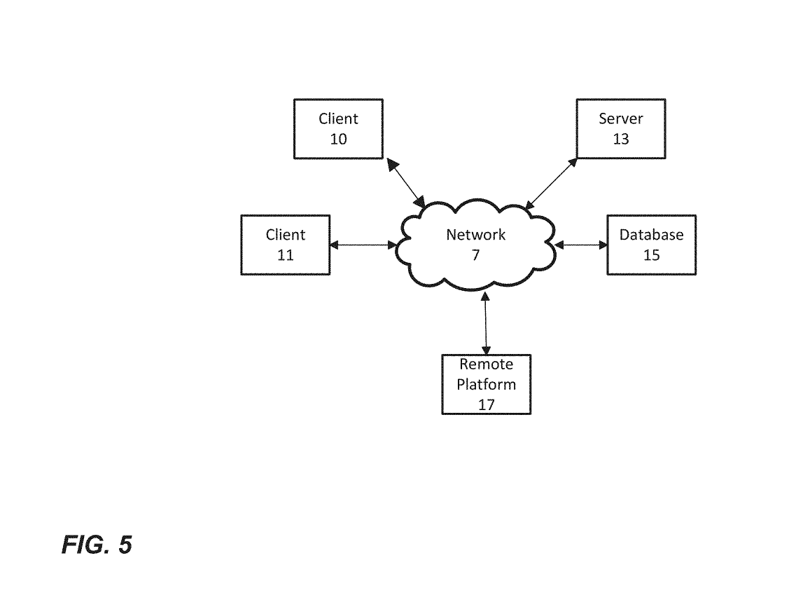

FIG. 5 shows an example network arrangement according to an embodiment of the disclosed subject matter. One or more clients 10, 11, such as computing devices including, but not limited to, local computers, smartphones, smart watches, game consoles, tablet computing devices, and the like may connect to other devices via one or more networks 7. As described earlier, the communication partner may operate a client device that is remote from the device operated by the user (e.g., in separate locations). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing embodiments of the disclosed subject matter.

When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A system, comprising:
a non-transitory memory for storing instructions;
one or more hardware processors that are coupled to the non-transitory memory and that are configured to execute the instructions to cause the system to perform operations comprising:
providing a finite number of virtual currency packages to an application store, each of the virtual currency packages being provided by the application store in exchange for an amount of real currency;
maintaining a plurality of unlockable content packages for an application on a server that is not associated with the application store, wherein each of the plurality of unlockable content packages has an associated virtual currency amount that is required to access the unlockable content in the application;
receiving a request to access one of the plurality of unlockable content packages;
determining one of the virtual currency packages on the application store to present as a selectable option in the application operating on a computing device, wherein the one of the virtual currency packages provides at least a minimum amount of virtual currency to access the one of the plurality of unlockable content packages;
receiving a selection of the one of the virtual currency packages;
automatically purchasing the one of the plurality of virtual currency packages and exchanging the virtual currency for access to the one of the plurality of unlockable content packages, wherein access to the one of the plurality of unlockable content packages comprises sending the computing device the one of the plurality of unlockable content packages for execution on the computing device.

2. The system of claim 1, wherein the wherein an indication of the one of the virtual currency packages is sent to the computing device.

3. The system of claim 1, wherein the receipt of a selection of the one of the virtual currency packages further comprises receipt of authorization to transact an exchange of real currency for the one of the plurality of virtual currency packages on the application store.

4. The system of claim 1, wherein the operations further comprise:
determining a difference between the amount of virtual currency required to access the one of the plurality of unlockable content packages and an amount of virtual currency provided by the one of the plurality of virtual currency packages;
generating a message comprising an indication of the difference for display in the application on the computing device.

5. The system of claim 1, wherein the operations further comprise:
receiving an indication of an amount of virtual currency associated with a user of the application on the computing device, wherein the selection of the one the plurality of virtual currency packages to present with the selectable option is based upon the amount of virtual currency associated with the user of the application on the computing device.

6. A system, comprising:
a non-transitory memory for storing instructions;
one or more hardware processors that are coupled to the non-transitory memory and that are configured to execute the instructions to cause the system to perform operations comprising:
determining an amount of a virtual currency required to access the unlockable content for the application;
comparing the amount of virtual currency required to access the unlockable content to a plurality of virtual currency packages available on an application store that is communicatively coupled to the computing device, the plurality of virtual currency packages being available for purchase with real currency;
selecting one of the plurality of virtual currency packages to present as a selectable option, wherein the one of the plurality of virtual currency packages provides at least the amount of virtual currency required to access the unlockable content;
presenting the selectable option to access to the unlockable content, the selectable option comprising the one of the plurality of virtual currency packages with a cost of the one of the plurality of virtual currency packages displayed in real currency simultaneously with a display of the amount of virtual currency required to access the unlockable content;
receiving a selection of the one of the plurality of virtual currency packages; and
automatically purchasing the unlockable content for the application thereby making the unlockable content accessible to the application.

7. The system of claim 6, wherein the operations further comprise:
receiving, by an application operating on a computing device, a request to provide access to unlockable content for the application.

8. The system of claim 6, wherein an amount of currency provided by the one of the plurality of virtual currency packages exceeds the amount of virtual currency required to access the unlockable content for the application.

9. The system of claim 8, wherein the operations further comprise:
determining a difference between the amount of virtual currency required to access the unlockable content and the amount of virtual currency provided by the one of the plurality of virtual currency packages;
generating a message comprising an indication of the difference; and
displaying the message in the application on the computing device.

10. The system of claim 6, wherein the operations further comprise:
determining an amount of virtual currency associated with a user of the application on the computing device, wherein the selection of the one the plurality of virtual currency packages to present with the selectable option is based upon the amount of virtual currency associated with the user of the application on the computing device.

11. The system of claim 6, wherein the determination of the amount of the virtual currency required to access the unlockable content for the application comprises communicating with a server of a developer of the application.

12. The system of claim 6, wherein the operations further comprise:
receiving a package from a server of a developer of the application, the package comprising the unlockable content; and
executing the package to install the unlockable content.

13. A computer-implemented method, comprising:
determining an amount of a virtual currency required to access the unlockable content for the application;
comparing the amount of virtual currency required to access the unlockable content to a plurality of virtual currency packages available on an application store that is communicatively coupled to the computing device, the plurality of virtual currency packages being available for purchase with real currency;
selecting one of the plurality of virtual currency packages to present as a selectable option, wherein the one of the plurality of virtual currency packages provides at least the amount of virtual currency required to access the unlockable content;
presenting the selectable option to access to the unlockable content, the selectable option comprising a the one of the plurality of virtual currency packages with a cost of the one of the plurality of virtual currency packages displayed in real currency simultaneously with a display of the amount of virtual currency required to access the unlockable content;
receiving a selection of the one of the plurality of virtual currency packages; and
automatically purchasing the unlockable content for the application thereby making the unlockable content accessible to the application.

14. The computer-implemented method of claim 13, further comprising:
receiving, by an application operating on a computing device, a request to provide access to unlockable content for the application;

15. The computer-implemented method of claim 13, wherein an amount of currency provided by the one of the plurality of virtual currency packages exceeds the amount of virtual currency required to access the unlockable content for the application.

16. The computer-implemented method of claim 15, further comprising:
determining a difference between the amount of virtual currency required to access the unlockable content and the amount of virtual currency provided by the one of the plurality of virtual currency packages;
generating a message comprising an indication of the difference; and
displaying the message in the application on the computing device.

17. The computer-implemented method of claim 13, further comprising:
determining an amount of virtual currency associated with a user of the application on the computing device, wherein the selection of the one of the plurality of virtual currency packages to present with the selectable option is based upon the amount of virtual currency associated with the user of the application on the computing device.

18. The computer-implemented method of claim 13, wherein the determination of the amount of the virtual currency required to access the unlockable content for the application comprises communicating with a server of a developer of the application.

19. The computer-implemented method of claim 13, wherein the operations further comprise:
receiving a package from a server of a developer of the application, the package comprising the unlockable content; and
executing the package to install the unlockable content.

20-35. (canceled)
